(19) United States
(12) Patent Application Publication
(10) Pub. No.: US 2007/0202311 A1
(43) Pub. Date: Aug. 30, 2007

(54) Multi-layer release films

(75) Inventors: Gwo Swei, Vandalia, OH (US); John R. Kastelic, Houston, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 11/364,833

(22) Filed: Feb. 28, 2006

(51) Int. Cl. B32B 7/02; B32B 25/04; B32B 27/00; B05D 7/00

(52) U.S. Cl. 428/213; 428/492; 428/494; 428/421; 428/215; 428/216; 428/422; 427/407.1

(57) ABSTRACT

A multilayer film including a first layer including a curable elastomer and a second layer bonded directly to and directly contacting the first layer. The second layer includes a fluoropolymer and has a thickness less than 5.0 microns. The multilayer film has a thickness ratio of at least about 5. The thickness ratio is a ratio of the thickness of the first layer to the thickness of the second layer. The multilayer film has generally parallel and planar opposite major surfaces.

### FIELD OF THE DISCLOSURE

This disclosure, in general, relates to multi-layer release films and methods for making such films.

### BACKGROUND

Increasingly, manufacturers are seeking polymers to create surfaces that are resistant to chemical and environmental damage. In addition, manufacturers are seeking films that have release characteristics, forming a surface that is resistant to adhesion with other surfaces. In particular applications, films formed of such polymers have been used as airplane and train cargo holders, vinyl siding surface treatments, photovoltaic protective coverings, and release films. An example of such polymers includes low surface energy polymers. Low surface energy polymers, such as fluoropolymers, exhibit a resistant to damage caused by exposure to chemicals, such as methyl ethyl ketone (MEK), have a resistance to stains, demonstrate a resistance to damage caused by exposure to environmental conditions, and typically, form a release surface.

While such low surface energy polymers are in demand, the polymers tend to be expensive. In addition, such polymers exhibit low wetting characteristics and given their tendency to form a release surface, adhere poorly with other polymer substrates. For particular fluoropolymers, such as PVDF, manufacturers have turned to adhesive layers including acrylic polymers or carboxylic acid functional modified polyolefins to adhere the fluoropolymer layer to incompatible substrates. However, acrylic polymers are typically less tolerant of environmental stresses, such as ultraviolet light exposure and high temperature. As such, the bond between a fluoropolymer layer film and an underlying substrate may degrade with time. Moreover, mismatches between mechanical properties of an underlying substrate and a fluoropolymer layer degrade the contact between the layers and the substrate with ongoing mechanical stress, resulting in reduced peel strength and a potential degradation of the bond between the fluoropolymer layer and the underlying film layer.

As such, an improved multi-layer film and a method for manufacturing such multi-layer films would be desirable.

### SUMMARY

In a particular embodiment, a multilayer film including a first layer including a curable elastomer and a second layer bonded directly to and directly contacting the first layer. The second layer includes a fluoropolymer and has a thickness less than 5.0 microns. The multilayer film has a thickness ratio of at least about 5. The thickness ratio is a ratio of the thickness of the first layer to the thickness of the second layer. The multilayer film has generally parallel and planar opposite major surfaces.

In another exemplary embodiment, a multilayer film includes a first layer including a diene elastomer. The first layer has first and second opposite major surfaces. The multilayer film also includes a second layer bonded directly to and directly contacting the first major surface of the first layer. The second layer includes a fluoropolymer. The ratio of the thickness of the first layer to the thickness of the second layer is at least about 5. The multilayer film further includes a third layer bonded directly to and directly contacting the second major surface of the first layer. The third layer includes a fluoropolymer.

In a further exemplary embodiment, a method of forming a multilayer film includes extruding a first layer comprising a curable elastomer, extruding a second layer in contact with the first layer to form an uncured multilayer film, and curing the uncured multilayer film. The second layer includes a fluoropolymer. A thickness ratio of a thickness of the first layer to a thickness of the second layer is at least about 5.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary multi-layer film.

### DESCRIPTION OF THE DRAWINGS

In a particular embodiment, a multi-layer film includes first and second layers. The first layer may include a curable elastomer. For example, the curable elastomer may include a diene elastomer. The second layer includes a low surface energy polymer. For example, the low surface energy polymer may include a fluoropolymer. The second layer is bonded directly to and directly contacts the first layer. The ratio of a thickness of the first layer to a thickness of the second layer may be at least about 5. In an exemplary embodiment, the multi-layer film may also include a third layer bonded directly to and directly contacting the first layer. The third layer may include, for example, the low surface energy polymer. In a particular example, the second and third layers form opposite outermost layers of the multi-layer film. In addition, the layers may form generally parallel and planar opposite major surfaces.

In an exemplary embodiment, the multi-layer film may be formed by extruding a first layer and extruding a second layer. The ratio of a thickness of the first layer to a thickness of the second layer is at least about 5. In an example, the first layer includes a curable elastomer, such as a diene elastomer. The second layer includes a low surface energy polymer. In an exemplary embodiment, the first and second layers are coextruded so as to directly contact each other. In addition, the first layer may be cured, such as through crosslinking. For example, the multi-layer film may be exposed to radiation, such as e-beam radiation or ultraviolet electromagnetic radiation. Alternatively, water activated crosslinking agents may be used to cure the curable elastomer of the first layer.

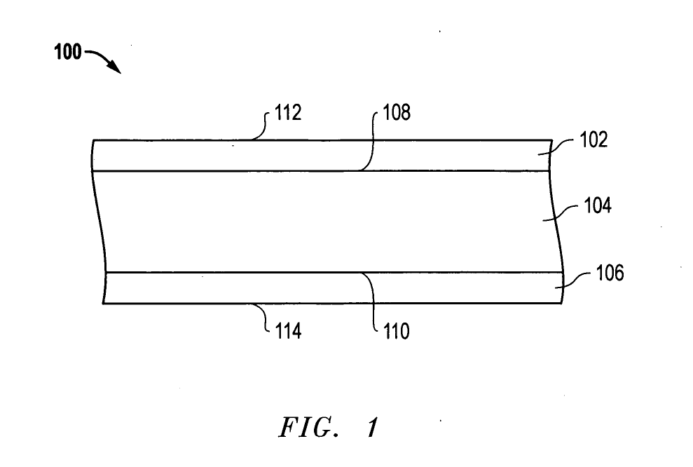

As illustrated in FIG. 1, a multi-layer film 100 may include a layer 102, which forms an outermost surface 112. The layer 102 may be bonded to a layer 104 along a major surface 108 of the layer 104. In an exemplary embodiment, the multi-layer film 100 includes two layers, such as the layer 102 and the layer 104. Alternatively, the multi-layer film 100 may include two or more layers, such as three layers. For example, a third layer 106 may be bonded to a second major surface 110 of the layer 104. The second major surface 110 is, for example, a major surface opposite the major surface 108. In such an example, the third layer 106 may form an outermost surface 114 opposite the outermost surface 112. In a further alternative embodiment, the layer 104 may be formed of multiple core or intermediate layers.

In general, the intermediate layer 104 has greater thickness than the outermost layer 102 or optional outermost layer 106. For example, an outermost layer, such as the layer 102 and optionally, the layer 106, may form not greater than about 20% by volume of the multi-layer film 100. For example, the layer 102 may form not greater than about 15% by volume of the multi-layer film 100, such as not greater than about 10% by volume of the multi-layer film 100. In particular examples, the outermost layer 102 and optionally, the outermost layer 106 may each form not greater than 5% by volume of the multilayer film, such as not greater than 3% by volume, not greater than 2% by volume, or not greater than 1% by volume or less. In a further example, the outermost layer 102 and optionally, the outermost layer 106 may have a thickness less than about 5.0 microns. For example, the thickness may be not greater than about 4.5 microns, such as not greater than about 3.5 microns, not greater than about 2.5 microns, or not greater than about 1.3 microns. The intermediate layer 104 may form at least about 60% by volume of the multi-layer film 100, such as at least about 70% by volume or at least about 80% by volume of the multi-layer film 100. In a particular example, the intermediate layer 104 forms at least about 90% by volume, such as at least about 95% by volume or at least about 97% by volume of the multilayer film. In a further example, the intermediate layer 104 may have a thickness at least about 12.0 microns, such as at least about 25.0 microns, at least about 50.0 microns, at least about 100.00 microns, or at least about 200.0 microns.

In a particular embodiment, the thickness ratio, defined as the ratio of the thickness of the intermediate layer 104 to the thickness of the outermost layer 102, is at least about 5. For example, the thickness ratio may be at least about 10, such as at least about 20, at least about 50 or at least about 100.

The total film thickness of the multi-layer film 100 may be at least about 13 microns. For example, the multi-layer film 100 may have a total thickness of at least about 25 microns, such as at least about 50 microns, at least about 100 microns, at least about 200 microns, or at least about 250 microns or higher.

In an exemplary embodiment, the layer 102 includes material formed of a low surface energy polymer. For example, a low surface energy polymer may be a polymer that has a tendency to form a low surface energy surface. In an example, a low surface energy polymer includes a fluoropolymer. In a further example, the fluoropolymer may be a perfluorinated polymer. An exemplary fluoropolymer may be formed of a homopolymer, copolymer, terpolymer, or polymer blend formed from a monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof. An exemplary fluoropolymer includes a fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), poly vinylidene fluoride (PVDF), a terpolymer including tetrafluoroethylene, hexafluoropropylene, and vinylidene fluoride (THV), or any blend or any alloy thereof. For example, the fluoropolymer may include FEP. In a further example, the fluoropolymer may include PVDF. In an exemplary embodiment, the fluoropolymer may be a polymer crosslinkable through radiation, such as e-beam. An exemplary crosslinkable fluoropolymer may include ETFE, THV, PVDF, or any combination thereof. A THV resin is available from Dyneon 3M Corporation Minneapolis, Minn. An ECTFE polymer is available from Ausimont Corporation (Italy) under the trade name Halar. Other fluoropolymers used herein may be obtained from Daikin (Japan) and DuPont (USA). In particular, FEP fluoropolymers are commercially available from Daikin, such as NP-12X.

In an exemplary embodiment, the layer 104 includes a material formed of an elastomeric material. In a particular embodiment, the elastomeric material includes a curable elastomer. An example, of a curable elastomer includes a silicone elastomer, a crosslinkable fluoropolymer, a diene elastomer, or any combination thereof. In a particular example, the layer 104 may include a diene elastomer. In another example, the elastomeric material includes a blend of a diene elastomer and a polyolefin. Typically, the diene elastomer is a copolymer formed from at least one diene monomer. For example, the diene elastomer may be a copolymer of ethylene, propylene and diene monomer (EPDM). An exemplary diene monomer includes a conjugated diene, such as butadiene, isoprene, chloroprene, or the like; a non-conjugated diene including from 5 to about 25 carbon atoms, such as 1,4-pentadiene, 1,4-hexadiene, 1,5-hexadiene, 2,5-dimethyl-1,5-hexadiene, 1,4-octadiene, or the like; a cyclic diene, such as cyclopentadiene, cyclohexadiene, cyclooctadiene, dicyclopentadiene, or the like; a vinyl cyclic ene, such as 1-vinyl-1-cyclopentene, 1-vinyl-1-cyclohexene, or the like; an alkylbicyclononadiene, such as 3-methylbicyclo-(4,2,1)-nona-3,7-diene, or the like; an indene, such as methyl tetrahydroindene, or the like; an alkenyl norbornene, such as 5-ethylidene-2-norbornene, 5-butylidene-2-norbornene, 2-methallyl-5-norbornene, 2-isopropenyl-5-norbornene, 5-(1,5-hexadienyl)-2-norbornene, 5-(3,7-octadienyl)-2-norbornene, or the like; a tricyclodiene, such as 3-methyltricyclo (5,2,1,0², 6)-deca-3,8-diene or the like; or any combination thereof. In a particular embodiment, the diene includes a non-conjugated diene. In another embodiment, the diene elastomer includes alkenyl norbornene. The diene elastomer may include, for example, ethylene from about 63 wt % to about 95 wt % of the polymer, propylene from about 5 wt % to about 37 wt %, and the diene monomer from about 0.2 wt % to about 15 wt %, based upon the total weight of the diene elastomer. In a particular example, the ethylene content is from about 70 wt % to about 90 wt %, propylene from about 17 wt % to about 31 wt %, and the diene monomer from about 2 wt % to about 10 wt % of the diene elastomer. The diene elastomer typically has a Mooney viscosity of at least about 20, such as about 25 to about 150 (ML 1+8 at 125° C.). In an exemplary embodiment, the diene elastomer has a dilute solution viscosity (DSV) of at least about 1, such as about 1.3 to about 3 measured at 25° C. as a solution of 0.1 grams of diene polymer per deciliter of toluene. Prior to crosslinking, the diene elastomer may have a green tensile strength of about 800 psi to about 1,800 psi, such as about 900 psi to about 1,600 psi. The uncrosslinked diene elastomer may have an elongation at break of at least about 600 percent. In general, the diene elastomer includes a small amount of a diene monomer, such as a dicyclopentadiene, a ethylnorbornene, a methylnorbornene, a non-conjugated hexadiene, or the like, and typically have a number average molecular weight of from about 50,000 to about 100,000. Exemplary diene elastomers are commercially available under the tradename Nordel from Dow Dupont.

When the curable elastomer includes a blend of a diene elastomer and a polyolefin, the polyolefin of the blend may include a homopolymer, a copolymer, a terpolymer, an alloy, or any combination thereof formed from a monomer, such as ethylene, propylene, butene, pentene, methyl pentene, octene, or any combination thereof. An exemplary polyolefin includes high density polyethylene (HDPE), medium density polyethylene (MDPE), low density polyethylene (LDPE), ultra low density polyethylene, ethylene propylene copolymer, ethylene butene copolymer, polypropylene (PP), polybutene, polypentene, polymethylpentene, polystyrene, ethylene propylene rubber (EPR), ethylene octene copolymer, or any combination thereof. In a particular example, the polyolefin includes high density polyethylene. In another example, the polyolefin includes polypropylene. In a further example, the polyolefin includes ethylene octene copolymer. In a particular embodiment, the polyolefin is not a modified polyolefin, such as a carboxylic functional group modified polyolefin, and in particular, is not ethylene vinyl acetate. In addition, the polyolefin is not formed from a diene monomer. In a particular example, the polyolefin has a degree of crystallinity. For example, the polyolefin may have at least about 35% crystallinity. In a particular example, the polyolefin may have a crystallinity of at least about 50%, such as at least about 60% or at least about 70% crystallinity. In a particular example, the polyolefin may be a high crystallinity polyolefin. Alternatively, the polyolefin may be a low crystallinity polyolefin, having a crystallinity not greater than 35%. Low crystallinity polyolefins may enhance conformability of release films or improve clarity. An exemplary commercially available polyolefin includes Equistar 8540, an ethylene octene copolymer; Equistar GA-502-024, an LLDPE; Dow DMDA-8904NT 7, an HDPE; Basell Pro-Fax SR275M, a random polypropylene copolymer; Dow 7C50, a block PP copolymer; or products formerly sold under the tradename Engage by Dupont Dow.

In an example, the blend includes not greater than about 40 wt % polyolefin, such as not greater than about 30 wt % polyolefin. For example, the blends may include not greater than about 20 wt % of the polyolefin, such as not greater than 10 wt %. In a particular example, the blend includes about 5 wt % to about 30 wt %, such as about 10 wt % to about 30 wt %, about 10 wt % to about 25 wt %, or about 10 wt % to about 20 wt %.

In general, the blend exhibits compatibility between the polymeric components. DMA analysis may provide evidence of compatibility. DMA analysis may show a single tan delta peak between glass transition temperatures of major components of a blend, indicating compatibility. Alternatively, an incompatible blend may exhibit more than one tan delta peak. In an example, the blend may exhibit a single tan delta peak. In particular, the single tan delta peak may be between the glass transition temperature of the polyolefin and the glass transition temperature of the diene elastomer.

In general, curable elastomer may be cured through crosslinking. In a particular example, a curable elastomer may be crosslinkable through radiation, such as using X-ray radiation, gamma radiation, ultraviolet electromagnetic radiation, visible light radiation, electron beam (e-beam) radiation, or any combination thereof. In a particular example, the radiation may be actinic radiation. Ultraviolet (UV) radiation may include radiation at a wavelength or a plurality of wavelengths in the range of from 170 nm to 400 nm, such as 170 nm to 220 nm. Ionizing radiation includes high-energy radiation capable of generating ions and includes electron beam (e-beam) radiation, gamma radiation, and X-ray radiation. In a particular example, e-beam ionizing radiation includes an electron beam generated by a Van de Graaff generator, an electron-accelerator, or an X-ray. In an alternative embodiment, the curable elastomer may be crosslinkable through thermal methods. In a further example, the curable elastomer may be crosslinkable through chemical reaction, such as a reaction between a silane crosslinking agent and water.

In an exemplary embodiment, the material of the intermediate layer 104 may further include a crosslinking agent, a photoinitiator, a filler, a plasticizer, or any combination thereof. Alternatively, the blend may be free of crosslinking agents, photoinitiators, fillers, or plasticizers. In particular, the blend may be free of photoinitiators or crosslinking agents.

To facilitate crosslinking, the material of the elastomeric layer 104 may include an initiator. For example, the material of the elastomeric layer 104 may include a photoinitiator or a sensibilizer composition. For example, when ultra-violet radiation is contemplated as the form of irradiation or when e-beam radiation is contemplated as the form of irradiation, the material may include a photoinitiator to increase the crosslinking efficiency, i.e., degree of crosslinking per unit dose of radiation.

An exemplary photoinitiator includes benzophenone, ortho- and para-methoxybenzophenone, dimethylbenzophenone, dimethoxybenzophenone, diphenoxybenzophenone, acetophenone, o-methoxy-acetophenone, acenaphthene-quinone, methyl ethyl ketone, valerophenone, hexanophenone, alpha-phenyl-butyrophenone, p-morpholinopropiophenone, dibenzosuberone, 4-morpholinobenzo-phenone, benzoin, benzoin methyl ether, 3-o-morpholinodeoxybenzoin, p-diacetyl-benzene, 4-aminobenzophenone, 4′-methoxyacetophenone, alpha-tetralone, 9-acetylphenanthrene, 2-acetyl-phenanthrene, 10-thioxanthenone, 3-acetyl-phenanthrene, 3-acetylindole, 9-fluorenone, 1-indanone, 1,3,5-triacetylbenzene, thioxanthen-9-one, xanthene-9-one, 7-H-benz[de]anthracen-7-one, benzoin tetrahydrophyranyl ether, 4,4′-bis(dimethylamino)-benzophenone, 1′-acetonaphthone, 2′ acetonaphthone, aceto-naphthone and 2,3-butanedione, benz[a]anthracene-7,12-dione, 2,2-dimethoxy-2-phenylaceto-phenone, alpha-diethoxy-acetophenone, alpha-dibutoxy-acetophenone, anthraquinone, isopropylthioxanthone, or any combination thereof. An exemplary polymeric initiator may include poly(ethylene/carbon monoxide), oligo[2-hydroxy-2-methyl-1-[4-(1-methylvinyl)-phenyl]propanone], polymethylvinyl ketone, polyvinylaryl ketones, or any combination thereof.

Another exemplary photoinitiator includes benzophenone; anthrone; xanthone; the Irgacure® series of photoinitiators from Ciba-Geigy Corp. including 2,2-dimethoxy-2-phenylacetophenone (Irgacure® 651), 1-hydroxycyclohexylphenyl ketone (Irgacure® 184), or 2-methyl-1-[4-(methylthio)phenyl]-2-moropholino propan-1-one (Irgacure® 907); or any combination thereof. Generally, the photoinitiator exhibits low migration from the material of the elastomeric layer 104. In addition, the photoinitiator typically has a low vapor pressure at extrusion temperatures and sufficient solubility in the polymer or polymer blends of the elastomeric layer 104 to yield efficient crosslinking. In an exemplary embodiment, the vapor pressure and solubility, or polymer compatibility, of the photoinitiator may be improved by derivatizing the photoinitiator. An exemplary derivatized photoinitiator includes, for example, higher molecular weight derivatives of benzophenone, such as 4-phenylbenzophenone, 4-allyloxybenzophenone, 4-dodecyloxybenzophenone, or any combination thereof. In an example, the photoinitiator may be covalently bonded to a polymer of the material of the elastomeric layer 104.

In an exemplary embodiment, the material of the elastomeric layer 104 includes about 0.0 wt % to about 3.0 wt % photoinitiator, such as about 0.1 wt % to about 2.0 wt %.

Crosslinking may also be facilitated by a chemical crosslinking agent, such as a peroxide, an amine, a silane, or any combination thereof. In an exemplary embodiment, the material of the elastomeric layer 104 may be prepared by dry blending solid state forms of polymer and the crosslinking agent, i.e., in powder form. Alternatively, the material may be prepared in liquid form, sorbed in inert powdered support or by preparing coated pellets, or the like.

An exemplary thermally activatable crosslinking agent includes a free radical generating chemical, which when exposed to heat decomposes to form at least one, and typically two or more free radicals to effect crosslinking. In an exemplary embodiment, the crosslinking agent is an organic crosslinking agent including an organic peroxide, an amine, a silane, or any combination thereof.

An exemplary organic peroxide includes 2,7-dimethyl-2,7-di(t-butylperoxy)octadiyne-3,5; 2,7-dimethyl-2,7-di(peroxy ethyl carbonate)octadiyne-3,5; 3,6-dimethyl-3,6-di(peroxy ethyl carbonate)octyne-4; 3,6-dimethyl-3,6-(t-butylperoxy)octyne-4; 2,5-dimethyl-2,5-di(peroxybenzoate)hexyne-3; 2,5-dimethyl-2,5-di(peroxy-n-propyl carbonate)hexyne-3; 2,5-dimethyl-2,5-di(peroxy isobutyl carbonate)hexyne-3; 2,5-dimethyl-2,5-di(peroxy ethyl carbonate)hexyne-3; 2,5-dimethyl-2,5-di(alpha-cumyl peroxy)hexyne-3; 2,5-dimethyl-2,5-di(peroxy beta-chloroethyl carbonate) hexyne-3; 2,5-dimethyl-2,5-di(t-butylperoxy) hexyne-3; or any combination thereof A particular crosslinking agent is 2,5-dimethyl-2,5-di(t-butyl peroxy)hexyne-3, available from Elf Atochem under the trade designation Lupersol 130. Another exemplary crosslinking agent is dicumyl peroxide, available from Elf Atochem as Luperox 500R. In a particular embodiment, the crosslinking agent is present in the material in an amount between about 0.1 wt % to about 5.0 wt %, such as about 0.5 wt % to about 2.0 wt % based on the weight of the material.

An exemplary silane crosslinking agent has the general formula: 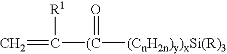
in which R1 is a hydrogen atom or methyl group; x and y are 0 or 1 with the proviso that when x is 1, y is 1; n is an integer from 1 to 12, preferably 1 to 4, and each R independently is a hydrolyzable organic group such as an alkoxy group having from 1 to 12 carbon atoms (e.g., methoxy, ethoxy, butoxy), aryloxy group (e.g., phenoxy), araloxy group (e.g., benzyloxy), aliphatic acyloxy group having from 1 to 12 carbon atoms (e.g., formyloxy, acetyloxy, propanoyloxy), amino or substituted amino groups (e.g., alkylamino, arylamino), or a lower alkyl group having 1 to 6 carbon atoms, with the proviso that not more than one of the three R groups is an alkyl. Such silanes may be grafted to a polymer through the use of an organic peroxide. Additional ingredients such as heat and light stabilizers, pigments, or any combination thereof, also may be included in the material. In general, the crosslinking reaction may result from a reaction between the grafted silane groups and water. Water may permeate into the bulk polymer from the atmosphere or from a water bath or “sauna”. An exemplary silane includes an unsaturated silane that comprise an ethylenically unsaturated hydrocarbyl group, such as a vinyl, allyl, isopropenyl, butenyl, cyclohexenyl or gamma-(meth)acryloxy allyl group, and a hydrolyzable group, such as, for example, a hydrocarbyloxy, hydrocarbonyloxy, or hydrocarbylamino group. An example of a hydrolyzable group includes a methoxy group, an ethoxy group, a formyloxy group, an acetoxy group, a proprionyloxy group, an alkyl group, an arylamino group, or any combination thereof. A particular silane is an unsaturated alkoxy silanes that can be grafted onto the polymer. In particular, the silane may include vinyl trimethoxy silane, vinyl triethoxy silane, gamma-(meth)acryloxy propyl trimethoxy silane, or any combination thereof.

The amount of silane crosslinker may vary widely depending upon the nature of the blend, the silane, the processing conditions, the grafting efficiency, the ultimate application, and similar factors. Typically, at least 0.5 parts per hundred resin (phr), such as at least about 0.7 phr, is used. Generally, the amount of silane crosslinker does not exceed 5 phr, such as not greater than about 2 phr.

In another exemplary embodiment, an amine crosslinking agent may include a monoalkyl, duallyl or trialkyl monoamine, wherein the alkyl group contains from about 2 to about 14 carbon atoms; a trialkylene diamine of the formula N(R²)₃N; a dialkylene diamine of the formula HN(R²)₂NH; an alkylene diamine, H₂NR²NH₂; a dialkylene triamine, H₂NR²NHR²NH₂; an aliphatic amine having a cyclic chain of from four to six carbon atoms; or any combination thereof. The alkylene group R² in the above formulae may include from about 2 to about 14 carbon atoms. An exemplary cyclic amine may have a heteroatom, such as oxygen, for example, an N-alkyl morpholine. Another exemplary cyclic amine includes pyridine, N,N-dialkyl cyclohexylamine, or any combination thereof. An exemplary amine is triethylamine; di-n-propylamine; tri-n-propylamine; n-butylamine; cyclohexylamine; triethylenediamine; ethylenediamine; propylenediamine; hexamethylenediamine; N,N-diethyl cyclohexylamine; pyridine; ethyl-p-dimethyl amine benzoate (EDAB); octyl-p-dimethyl aminobenzoate (ODAB); or any combination thereof. In an exemplary embodiment, the material includes from about 0.5 wt % to about 10.0 wt % of the amine.

In a particular example, curing is enhanced using FirstCure ITX, available from Albemarle, Inc. FirstCure ITX may also be used in conjunction with an amine synergist, such as ethyl-p-dimethyl amine benzoate (EDAB) or octyl-p-dimethyl aminobenzoate (ODAB).

Returning to FIG. 1, the multi-layer film 100 may be formed through a method, such as coextrusion, colamination, extrusion lamination, melt coating of a preformed layer, or comolding. In particular, co-extrusion may produce a film or a sheet. For example, a sheet of each layer 102, 104, and optionally, 106 may be extruded and placed together while in a heat-softened condition in the co-extrusion die or after the outlet of the die to form a pre-formed article. When chemical crosslinkers are present, crosslinking may occur. Alternatively, the sheet may be subjected to radiation crosslinking.

Once the multilayer article is pre-formed, crosslinking may be performed. In an example, crosslinking may effect bonding of the layers 102, 104, and optionally, 106 together. Such crosslinking may alter mechanical properties of the elastomeric layer 104 and improve peel strength between the layers 102, 104, and 106. Crosslinking may be performed at elevated temperature, such as when the layers 102, 104, and optionally, 106 are placed together at above the melting point of either component, at room temperature, or at any temperature in between.

To illustrate crosslinking by radiation, a film is prepared by the extrusion process. In the extrusion process, the material of layer 102, the material of layer 104, and optionally, the material of layer 106 may be separately melted and separately supplied or jointly melted and supplied to a co-extrusion feed block and die head wherein a film including the layers 102, 104, and optionally 106 is generated. An exemplary die employs a “coat hanger” type configuration. An exemplary linear coat hanger die head is commercially available from Extrusion Dies, Inc. (Connecticut) or Cloeren Die Corp., (Texas). In an exemplary embodiment, the coextruded multilayer film is drawn at a ratio not greater than 30:1, such as not greater than 20:1. Alternatively, the extruded layers may be pressed together at pressures in the range of 0.1 MPa to 80 MPa.

Once the film is formed, radiation crosslinking may be immediately performed and the film may be rolled. Alternatively, the film may be rolled in an uncrosslinked state, unrolled at a later time and subjected to radiation crosslinking.

The radiation may be effective to create crosslinks in the crosslinkable polymer of the layer 104. The intralayer crosslinking of polymer molecules within the layer 104 provides a cured composition and imparts structural strength to the layer 104 of the multi-layer film 100. In addition, radiation crosslinking may effect a bond between an outermost layer 102 formed of a fluoropolymer and the core layer 104, such as through interlayer crosslinking. In a particular embodiment, the combination of interlayer crosslinking bonds between the layers and the cured core layer present an integrated composite that is highly resistant to delamination, has a high quality of adhesion resistant and protective surface, incorporates a minimum amount of adhesion resistant material, and yet, is physically substantial for convenient handling and deployment of the multilayer film 100. In a particular embodiment, films having a thickness ratio at least about 5, such as at least about 10, form an effective interlayer bond with less curing or crosslinking. Further, multilayer films having a thickness ratio at least about 5, such as at least about 10, are resistant to delamination, even with lower absolute peel strength. For example, the multilayer film may exhibit a peel strength of at least about 5 gm/cm of width, when tested in standard “T”-Peel configuration at room temperature. In particular, thinner films below 1 mil in thickness may have a peel strength of at least about 5 gm/cm, such as at least about 10 gm/cm or at least about 20 gm/cm. In another example, the peel strength of the multilayer film may be at least about 30 gm/cm, such as at least about 40 gm/cm, at least about 45 gm/cm, or even at least about 50 gm/cm. In particular, thicker films or films used in conjunction with adhesive tapes over a wide temperature range may have peel strengths of at least about 30 gm/cm.

In a particular embodiment, the radiation may be ultraviolet electromagnetic radiation having a wavelength between 170 nm and 400 nm, such as about 170 nm to about 220 nm. Crosslinking may be effected using at least about 120 J/cm² radiation.

Once formed and cured, the multi-layer polymer film may exhibit desirable mechanical properties. For example, the multi-layer polymer film may have a tensile strength of at least about 12 MPa, based on ASTM D882-02 testing methods. For example, the multi-layer film may have a tensile strength of at least about 15 MPa, such as at least about 20 MPa.

In another exemplary embodiment, the multi-layer film exhibits a desirable elongation at ultimate tensile strength based on ASTM D882-02 testing methods. For example, the multi-layer film may exhibit an elongation at ultimate tensile strength of at least about 145%, such as at least about 170% or at least about 200%.

Particular embodiments of a multilayer film advantageously exhibit improved mechanical properties while maintaining crosslinkability and interlayer bonding. For example, embodiments of a multilayer film may exhibit intracrosslinking within the core layer and bonding between the core layer and the outermost layer of fluoropolymer without the use of an intervening adhesive layer. Further, embodiments of the multilayer film may exhibit effective interfacial bonding at low radiation exposure or with lower peel strength. In addition, embodiments may unexpectedly exhibit desirable coefficients of friction.

### EXAMPLES

### Example 1

Five polymers are selected for a blending study. Specifically, blends are formed that include EPDM and one of five commercially available polyolefins. The commercially available polyolefins are Equistar 8540, an ethylene octene copolymer; Equistar GA-502-024, an LLDPE; Dow DMDA-8904NT 7, an HDPE; Basell Pro-Fax SR275M, a random polypropylene copolymer; and Dow 7C50, a block PP copolymer. The selected EPDM grade is Nordel 4725, available from Dupont-Dow. A blend including the EPDM and at least one polyolefin is included as an intermediate or core layer of a multi-layer film that includes outermost layers formed from Daikin NP-12X FEP. The multi-layer film is coextruded and exposed to ultraviolet electromagnetic radiation, curing the blend of the core layer.

The multi-layer films are coextruded to 1 mil in thickness and exposed to ultraviolet radiation generated by an H+ bulb included in a Fusion UV Systems Model VPS-6 system. The samples are exposed through multiple passes to ultraviolet radiation for a total exposure of 129 J/cm². The blends did not include a photoinitiator.

Dynamic mechanical analysis (DMA) is used to evaluate the compatibility of the blends. The tan delta peak of a DMA scan provides the glass transition temperature (T_{g}) for the overall blend. In a compatible system, the T_{g} moves according to the relative amounts of each component in the binary blend, i.e., the T_{g} for the blend has an intermediate value relative to the glass transition temperature of the two components and the T_{g} value changes according to the relative amounts of the components. Alternatively, an incompatible blend behaves as at least two different materials and at least two tan delta peaks appear in the DMA scan. Each of the blends in the above-described samples exhibits a single tan delta peak between the glass transition temperatures of the component polymers.

### Example 2

Mechanical properties, such as the tensile strength and the percent elongation at ultimate tensile strength, of the samples are tested. The procedure follows ASTM D882-02. A cross head speed of 20 inches per minute with a 5 kN load cell is used. The samples are conditioned at 23° C. and 50 relative humidity (RH) for twelve hours prior to testing.

TABLE 1
Mechanical Properties for Films including Polymer Blends

| | Tensile Strength (MPa) | | |
|---|---|---|---|
| Polyolefin in Blend | 10 wt % | 20 wt % | 30 wt % |
| Ethylene Octene (Engage | 21.9 | 20.3 | 16.1 |
| 8540) | | | |
| LLDPE (Equistar) | 26.6 | 24.3 | 24.3 |
| HDPE (Dow DMDA) | 16.0 | 19.6 | 19.6 |
| PP (Dow 7C50) | 16.7 | 17.4 | 23.7 |
| PP (Basell ProFax) | 18.1 | 20.7 | 24.0 |

A comparative sample including 100% Nordel 4725 EPDM as a core layer has a tensile strength of 12.5 MPa. As illustrated in Table 1, each of the samples exhibits a tensile strength of at least about 12 MPa. Many of the samples including blends in intermediate or core layers exhibit a tensile strength of at least about 15 MPa and particular samples exhibit a tensile strength greater than 20 MPa. In general, addition of a polyolefin to the blend of the core layer increases the tensile strength of the sample relative to a sample including 100% Nordel 4725 EPDM in the core layer. Particular samples, such as the sample including a blend including linear low density polyethylene blend and the sample including a blend including ethylene octene copolymer exhibit peak tensile strength at approximately 10%. Other samples exhibit an increasing tensile strength at amounts as high as 30%, such as the sample including a blend including high density polyethylene and the sample including the blend including polypropylene block copolymer.

Percent elongation at ultimate tensile strength is also measured. A comparative sample including 100% Nordel 4725 EPDM as a core layer has an elongation at ultimate tensile strength of 149%. Table 2 includes the percent elongation for the above-described samples. Each of the samples exhibits an elongation at ultimate tensile strength of at least about 147%. The sample including the ethylene octene copolymer blend exhibits a peak percent elongation at a composition of between 10 and 20% of the ethylene octene copolymer. Other samples, such as the sample including the LLDP blend and the sample including the polypropylene random copolymer blend, exhibit increasing percent elongation at 30%.

TABLE 2
Mechanical Properties for Films including Polymer Blends

| | Elongation at Ultimate | | |
|---|---|---|---|
| | Tensile Strength (%) | | |
| Polyolefin in Blend | 10 wt % | 20 wt % | 30 wt % |
| Ethylene Octene (Engage | 250 | 240 | 111 |
| 8540) | | | |
| LLDPE (Equistar) | 172 | 220 | 240 |
| HDPE (Dow DMDA) | 196 | 205 | 194 |
| PP (Dow 7C50) | 198 | 226 | 223 |
| PP (Basell ProFax) | 154 | 188 | 236 |

### Example 3

A three layer film having the configuration A:B:A, where A and B represent layers formed of different materials, is extruded. The layer A is formed of Daikin NP-12X FEP, having an approximate melting point of 205° C. The layer B is formed of EPDM Nordel 1248 available from Dupont Dow, having an approximate melting point of 115° C. The materials are pre-dried for a period of approximately 8 hours at 60° C. prior to coextrusion. Regions of the extruder extruding the material of the layers A are set to 240° C., 280° C., 285° C., and 285° C. Regions of the extruder extruding the material of the layer B are set to 183° C., 220° C., 260° C., and 266° C. The material of layer B is processed through a 200-mesh screen. The feed block is set to 285° C., the die is set to 287° C., and the cast drum is set to 75° C. On a clean machine, the extruder of the material of the layer A is started to fill the die with FEP. The extruder of the material of the layer B is introduced once the die is filled with FEP.

A first sample of the film has a volume ratio of approximately 12%:77%:11 % for the respective layers A:B:A. The total film thickness is 33.6 microns. The layers A have thicknesses of approximately 4 microns each and the layer B has a thickness of approximately 25.6 microns. The thickness ratio is 6.4.

A second sample of the film has a volume ratio of approximately 12%:78%:10% for the respective layers A:B:A. The total film thickness is 30.2 microns. The layers A have thicknesses of approximately 3.5 microns and 3.3 microns, respectively, and the layer B has a thickness of approximately 23.4 microns. The thickness ratio is 7.1.

A third sample of the film has a volume ratio of approximately 7%:86%:7% for the respective layers A:B:A. The total film thickness is 30.7 microns. The layers A have thicknesses of approximately 2.0 microns each and the layer B has a thickness of approximately 26.7 microns. The thickness ratio is 13.3.

### Example 4

Following the method of EXAMPLE 3, a three layer film having the configuration A:B:A is formed, wherein the layers A include Daikin NP-12X FEP and the layer B includes Nordel 4920 EPDM by Dupont Dow.

Regions of the extruders extruding the material of both layers A are set to 288° C., 299° C., 321° C., 318° C., and 318° C. Regions of the extruder extruding the material of the layer B are set to 160° C., 188° C., 204° C., 215° C., 215° C., and 215° C. The material of layer B is processed through a 200-mesh screen. The feed block is set to 288° C., the die is set to 290° C., and the cast drum is set to 121° C. while secondary cooling roll is set to 74° C. On a clean machine, the extruder of the material of the layer A is started to fill the die with FEP. The extruder of the material of the layer B is introduced once the die is filled with FEP. Rotational rates of the extruder screws are adjusted to give the desired skin and and core layer thicknesses.

A sample of the film has a volume ratio of approximately 5%:90%:5% for the respective layers A:B:A. The total film thickness is 105.6 microns. The layers A have thicknesses of approximately 5.5 microns each and the layer B has a thickness of approximately 94.6 microns. The thickness ratio is 17.2. After exposure to ultraviolet radiation from an H+ 600 w/in bulb at 15 inches per minute, the sample exhibits a peel strength of 45 g/in.

### Example 5

Following the method of EXAMPLE 3, a three layer film having the configuration A:B:A is formed, wherein the layers A include Daikin NP-12X FEP and the layer B includes Nordel 4820 EPDM by Dupont Dow.

Regions of the extruders extruding the material of both layers A are set to 288° C., 298° C., 321° C., 318° C., and 318° C. Regions of the extruder extruding the material of the layer B are set to 160° C., 188° C., 204° C., 215° C., 215° C., and 215° C. The material of layer B is processed through a 200-mesh screen. The feed block is set to 293° C., the die is set to 290° C., and the cast drum is set to 93° C. while secondary cooling roll is set to 74° C. On a clean machine, the extruder of the material of the layer A is started to fill the die with FEP. The extruder of the material of the layer B is introduced once the die is filled with FEP. Rotational rates of the extruder screws are adjusted to give the desired skin and and core layer thicknesses.

A first sample of the film has a volume ratio of approximately 4%:92%:4% for the respective layers A:B:A. The total film thickness is 51.0 microns. The layers A have thicknesses of approximately 5.0 microns each and the layer B has a thickness of approximately 110.0 microns. The thickness ratio is 24.0.

A second sample of the film has a volume ratio of approximately 2%:96%:2% for the respective layers A:B:A. The total film thickness is 120 microns. The layers A have thicknesses of approximately 2.5 microns each and the layer B has a thickness of approximately 115 microns. The thickness ratio is 46.

### Example 6

Following the method of EXAMPLE 3, a three layer film having the configuration A:B:A is formed, wherein the layers A include Daikin NP-12X FEP and the layer B includes Nordel 4820 EPDM by Dupont Dow.

Regions of the extruders extruding the material of both layers A are set to 260° C., 299° C., 321° C., 321° C. and 315° C. Regions of the extruder extruding the material of the layer B are set to 100° C., 130° C., 170° C., 200° C., 215° C. and 215° C. The material of layer B is processed through a 200-mesh screen. The feed block is set to 282° C., the die is set to 280° C., and the cast drum is set to 135° C. while secondary cooling roll is set to 79° C. On a clean machine, the extruder of the material of the layer A is started to fill the die with FEP. The extruder of the material of the layer B is introduced once the die is filled with FEP. Rotational rates of the extruder screws are adjusted to give the desired skin and and core layer thicknesses. The machine is a full scale multilayer production line producing a web over 60 inches wide.

A sample of the film has a volume ratio of approximately 4%:92%:4% for the respective layers A:B:A. The total film thickness is 54 microns. The layers A have thicknesses of approximately 1.25 microns each and the layer B has a thickness of approximately 51.5 microns. The thickness ratio is 41.2 Skin layers appear contiguous even at thin thicknesses. Under close inspection over the entire 60-inch web width, no gaps or lines are apparent on either FEP skin surface where EPDM might be exposed. Thus the material appears functional as a release film. It is surprising that skin layers of such extremely fine thickness can be run in production scale equipment.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A multilayer film comprising:
a first layer comprising a curable elastomer;
a second layer bonded directly to and directly contacting the first layer, the second layer comprising a fluoropolymer and having a thickness less than 5.0 microns;
wherein the multilayer film has a thickness ratio of at least about 5, the thickness ratio being a ratio of a thickness of the first layer to a thickness of the second layer; and
wherein the multilayer film has generally parallel and planar opposite major surfaces.

2. The multilayer film of claim 1, wherein the thickness ratio is at least about 10.

3. The multilayer film of claim 2, wherein the thickness ratio is at least about 20.

4. (canceled)

5. The multilayer film of claim 1, wherein the thickness of the second layer is not greater than about 4.5 microns.

6. The multilayer film of claim 5, wherein the thickness of the second layer is not greater than about 3.5 microns.

7. The multilayer film of claim 6, wherein the thickness of the second layer is not greater than about 2.5 microns.

8. (canceled)

9. The multilayer film of claim 1, wherein the thickness of the first layer is at least about 12.0 microns.

10. The multilayer film of claim 9, wherein the thickness of the first layer is at least about 25.0 microns.

11. (canceled)

12. The multilayer film of claim 1, wherein the multilayer film has a total film thickness at least about 25.0 microns.

13.-17. (canceled)

18. The multilayer film of claim 1, wherein the curable elastomer comprises a diene elastomer.

19. (canceled)

20. The multilayer film of claim 1, wherein the curable elastomer comprises blend of a diene elastomer and a polyolefin.

21. The multilayer film of claim 1, wherein the fluoropolymer is selected from the group consisting of a fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), an ethylene tetrafluoroethylene copolymer (ETFE), an ethylene chlorotrifluoroethylene copolymer (ECTFE), polychlorotrifluoroethylene (PCTFE), poly vinylidene fluoride (PVDF), and a tetrafluoroethylene hexafluoropropylene vinylidene fluoride terpolymer (THV).

22. The multilayer film of claim 1, wherein the fluoropolymer comprises a perfluorinated polyolefin.

23. The multilayer film of claim 22, wherein the fluoropolymer comprises fluorinated ethylene propylene copolymer (FEP).

24.-27. (canceled)

28. The multilayer film of claim 1, further comprising a third layer comprising fluoropolymer bonded directly to and directly contacting the first layer on an opposite major surface from the second layer.

29. A multilayer film comprising:
a first layer comprising a diene elastomer, the first layer having first and second opposite major surfaces;
a second layer bonded directly to and directly contacting the first major surface of the first layer, the second layer comprising a fluoropolymer, wherein a thickness ratio of a thickness of the first layer to a thickness of the second layer is at least about 5; and
a third layer bonded directly to and directly contacting the second major surface of the first layer, the third layer comprising a fluoropolymer.

30. The multilayer film of claim 29, wherein the thickness ratio is at least about 10.

31. (canceled)

32. (canceled)

33. The multilayer film of claim 29, wherein the thickness of the second layer is not greater than about 4.5 microns.

34.-37. (canceled)

38. A method of forming a multilayer film, the method comprising:
extruding a first layer comprising a curable elastomer;
extruding a second layer in contact with the first layer to form an uncured multilayer film, the second layer comprising a fluoropolymer, a thickness ratio of a thickness of the first layer to a thickness of the second layer being at least about 5; and
curing the uncured multilayer film.

39. The method of claim 38, further comprising drawing the uncured multilayer film to a draw ratio not greater than 30:1.

40.-49. (canceled)
